(19) United States
(12) Patent Application Publication
(10) Pub. No.: US 2026/0059244 A1
(43) Pub. Date: Feb. 26, 2026

(54) HEARING INSTRUMENT

(71) Applicant: Sivantos Pte. Ltd., Singapore (SG)

(72) Inventor: Simon WÜNSCHE, Erlangen (DE)

(21) Appl. No.: 19/308,524

(22) Filed: Aug. 25, 2025

Related U.S. Application Data
(63) Continuation of application No. PCT/EP2024/073669, filed on Aug. 23, 2024.

(30) Foreign Application Priority Data
Sep. 6, 2024 (DE) 10 2024 208 513.8

(51) Int. Cl. H04R 25/00; G01S 7/35; G01S 13/58; G01S 13/86; G01S 13/89

(52) U.S. Cl. CPC H04R 25/40; G01S 7/356; G01S 13/584; G01S 13/86; G01S 13/89

(57) ABSTRACT

A hearing instrument has a device body to be worn on the body, particularly on the head, of a user. A continuous wave radar (CW) unit is arranged in or on the device body and configured to send out a (unmodulated) CW radar signal and to receive a corresponding reflected radar signal. A controller is configured to detect a signal portion characteristic of a micro-Doppler effect from a radar reception signal that is output by the CW radar unit upon receiving the reflected radar signal and to establish therefrom a distance of the device body from an object in a vicinity of the user.

### CROSS-REFERENCE TO RELATED APPLICATION

This application claims the priority of International Patent Application PCT/EP2024/073669, filed Aug. 23, 2024, and of German Patent Application DE 10 2024 208 513.8, filed Sep. 6, 2024; the prior applications are herewith incorporated by reference in their entirety.

### FIELD AND BACKGROUND OF THE INVENTION

The invention relates to a hearing instrument, for instance, a hearing aid.

Hearing instruments usually serve to output a sound signal to the auditory system of the wearer of the hearing device. Outputting is done by means of an output transducer, most commonly acoustically via airborne sound by means of a loudspeaker (also referred to as a “receiver”). Such hearing instruments are often employed as what are known as hearing assistive devices, generally referred to as hearing aids.

The hearing instruments typically comprise an acoustic input transducer (particularly a microphone) and a signal processor configured to process the input signal (also: microphone signal) generated by the input transducer from the ambient sound using at least one recorded, usually user-specific, signal processing algorithm such that a hearing impairment of the wearer of the hearing device is at least partially compensated for. Particularly in the case of a hearing aid, besides a loudspeaker, the output transducer may alternatively be a so-called bone conduction receiver or a cochlear implant configured for mechanically or electrically coupling the sound signal into the auditory system of the wearer. Apart from that, there are hearing instruments which protect or improve the hearing ability of users with normal hearing, for example, which are intended to enable improved understanding of speech in complex hearing situations. Such devices are also referred to as “Personal Sound Amplification Products” (PSAP). The term hearing instrument additionally also encompasses devices such as, e.g., so-called tinnitus maskers, headsets, earphones, and the like.

Typical designs of hearing instruments, particularly of hearing aids, are behind-the-ear (“BTE”) and in-the-ear (“ITE”) hearing instruments. These terms refer to the intended wearing position. As such, behind-the-ear hearing instruments have a (main) housing worn behind the auricle. Distinction may be made between models where loudspeakers are disposed within this housing—sound is output to the ear usually by means of a sound tube worn in the ear canal—and models having an external loudspeaker that is placed in the ear canal. In-the-ear hearing instruments (ITE) have a housing that is worn in the auricle or even entirely within the ear canal (CIC, completely in the canal).

The signal processor (which uses the at least one signal processing algorithm) of a hearing instrument is most commonly also configured to recognize different hearing situations and to adjust the signal processing as a function thereof. In part, hearing programs (most commonly realized by specific parameter sets for the, or the respective, signal processing algorithm) are recorded for this purpose, which are then “activated.” By way of example of this, hearing programs for music, conversations in a quiet environment, conversations with background noises, and the like are often cited. In part, different filters are also activated, deactivated, and their effect on the received signals is changed. For such hearing programs, but also for better filter adjustment, for instance, for speech recognition or improved speech reproduction, knowledge of the vicinity of the user of the hearing instrument is advantageous. For localization of sound sources (for instance, TV sets, audio playback devices, or the like), among other things, directivity may be generated and used by means of multiple microphones. If two hearing instruments (one for the respective ear) are used, the distance between the two hearing instruments can also be used here for better localization. Objects which are not acoustically active, however, cannot be located or can only be located on the basis of any detectable sound reflections.

### SUMMARY OF THE INVENTION

It is a primary object of the invention to enable the localization even of objects which are not acoustically active by means of a hearing instrument.

With the above and other objects in view there is provided, in accordance with the invention, a hearing instrument, comprising:
a device body to be worn on the body of a user;
a continuous wave (CW) radar unit arranged in or on said device body, said CW radar unit being configured to emit an unmodulated CW radar signal, to receive a corresponding reflected radar signal and to output a radar reception signal upon receiving the reflected radar signal; and
a controller configured to detect a signal portion characteristic of a micro-Doppler effect from the radar reception signal output by said CW radar unit and to establish therefrom a distance of said device body from an object in a vicinity of the user.

In other words, the hearing instrument according to the invention has a device body to be worn on the body, particularly on the head, of a user. Particularly, the hearing instrument is a hearing assistive device of the “behind-the-ear” (BTE) type with an integrated or even an external (“RIC” for “receiver in canal” or “ERU” for “external receiver unit”) loudspeaker. The hearing instrument also has a CW (“continuous wave”) radar unit arranged in or on the device body. The CW radar unit is configured to send out an unmodulated CW radar signal and to receive a corresponding reflected radar signal. Furthermore, the hearing instrument has a controller configured to detect a signal portion characteristic of a micro-Doppler effect from a radar reception signal that is generated by the CW radar unit upon receiving the reflected radar signal and to establish therefrom a distance of the device body from an object, which is particularly fixed in place, in a vicinity of the user.

Preferably, the radar unit is a “standard radar chipset” having integrated transmitting and receiving antennae as well as a signal generator and any further required components. This has the economic advantage that commercially available radar units can be used.

The invention assumes that “classic” radar ranging methods usually use pulsed and/or frequency-modulated radar signals. However, these are not applicable with the CW radar unit used according to the invention and, furthermore, require comparatively high computational effort and thus also energy expenditure. CW radar, in contrast, can be used for speed or motion detection by using, for instance, the Doppler effect. Objects moving past the user (for instance, passing motor vehicles, pedestrians, cyclists, and the like) may have a short-term influence on the acoustic impression of the user, however, their effect-particularly for adaptation of the signal processing due to the comparatively short duration—is rather negligible. However, the invention is nevertheless based on the finding that motion detection can be used for distance determination. However, this does not sense any movement of the object, but only its relative change in distance with respect to the user who is moving themselves because—and this is what the invention relies on-persons are normally always at least slightly in motion. Thus, the user of the hearing instrument will hardly ever hold their head exactly still. However, even slight movements are sufficient to be able to detect what are known as micro-Doppler effects in the reflected and received radar signal.

The term “micro-Doppler effect” is to be understood here and hereinafter to mean, particularly, an effect comparable to the “known” Doppler effect, but significantly smaller in intensity, which is small, particularly compared to the overall movements of a body, for instance, of a moving aircraft, a walking person, a traveling motor vehicle, which are usually sensed by means of the Doppler effect, and is most commonly due to movements of only part of the body (e.g., propeller of an aircraft, rotor of a helicopter, vibrations of the body, swinging arms of the walking person). This most commonly causes sidebands for a Doppler frequency shift caused by the overall movement of the body. That is, signal portions which indicate such an effect in their amplitude and/or frequency are therefore “characteristic” of such a micro-Doppler effect. As is known, the human body, when in motion, not only moves in its entirety, but always exhibits small movements of only body parts. For instance, a human's head moves constantly in at least small ranges of motion. The hearing instrument worn on the head thus also experiences these small movements. Micro-Doppler effects are described, for instance, in V. C. Chen, F. Li, S.-S. Ho and H. Wechsler, “Micro-Doppler effect in radar: phenomenon, model, and simulation study,” in IEEE Transactions on Aerospace and Electronic Systems, vol. 42, no. 1, pp. 2-21, January 2006, DOI: 10.1109/TAES.2006.1603402.

Such a detection of micro-Doppler effects, which are caused even by only slight movements, is comparatively simple by means of the CW radar unit. A DC-offset filter, which is most commonly present in the baseband of such a CW radar unit, would filter out any DC offset in the baseband which is generated when the CW radar signal is mixed with the reflected radar signal in the event that the CW radar unit and the object are invariable in location. However, as soon as micro-Dopplers—that is, a slight movement of the device body on the head of the user and thus also of the CW radar unit—are present, such a DC offset becomes sensable (i.e., particularly no longer filtered out by the filter).

This DC offset is preferably utilized as a measure of the signal power of the received reflected radar signal.

According to an expedient embodiment, the controller is configured to break down the radar reception signal, at least the signal portion characteristic of the micro-Doppler effect, into its frequency constituents, particularly by means of a fast Fourier transform (FFT).

According to a preferred embodiment, the controller is configured to, for establishing the distance, determine a digital FFT value of the characteristic signal portion, particularly of its DC offset. Preferentially, the controller is configured, as described above, to utilize this digital FFT value for the DC offset as a measure of the signal power. In principle, this procedure is underpinned by the finding that the digital FFT value becomes larger as the distance from the object, for instance, a wall of a room, decreases. This piece of information may therefore be used advantageously to establish the distance from the object.

That is to say, the controller is preferably configured to, for establishing the distance, compare the FFT value with a recorded amount of FFT comparison values, each of which is associated with a distance value. Preferentially, these multiple FFT comparison values are recorded in a table (“look-up table”/“LUT”) which in turn is stored in the controller, more precisely in a memory associated therewith. This is a procedure particularly low in computational effort.

Expediently, the controller is also configured to, for establishing the distance, utilize the (digital) FFT value of the characteristic signal portion at or in the range of (i.e., +/−20 Hz) the frequency of 0 Hz (i.e., to determine the digital FFT value for the DC offset at or around 0 Hz). This is based on the consideration that the “target objects” in the present case are preferentially stationary (particularly a wall of the room in which the user is located, and the like) as well as that, also, no movements are intended to be recognized.

According to a particularly expedient embodiment, the hearing instrument additionally has an inertial measurement unit arranged in or on the device body. This inertial measurement unit (“IMU”) is configured and provided for determining any change in orientation of at least the device body in space. For instance, the IMU is formed by a three-axis acceleration sensor or any other gyroscopic sensor or comprises such a sensor. In this case, the controller is preferentially configured to establish the distance of the device body from the object by means of the CW radar unit at least when a change in orientation of the device body is established by means of the inertial measurement unit. Particularly, the controller is configured to “verify” by means of the IMU whether or not the device body (and thus with a high probability also the user) moves and in what range of movement, for instance, whether there are only slight movements in the range of between 0.5 and 10 cm (or even only up to 5 cm) or larger movements (for instance, walking through the room, rotations of the entire body, or the like). Thereby, occurrence of a micro-Doppler effect in the received (reflected) radar signal due to a movement of the user can be distinguished from a micro-Doppler effect due to a movement of the object (for instance, when a door, a window casement, or even only leaves of a plant move). The micro-Doppler effects caused by the movement of the user themselves are of interest for establishing the distance. Optionally, the controller is also configured to determine whether or not the range of movement sensed by means of the IMU matches the “strength” of the micro-Doppler effect.

According to an expedient further development, the controller is also configured to create, on the basis of the distance as well as a piece of solid-angle information, established by means of the inertial measurement unit, on a viewing direction of the user, an ambient map, the distances between the hearing instrument and items in the vicinity of the user, that is, particularly from walls and/or any other objects in a room in which the user is located. This procedure is based on the consideration that the device body is always worn at least in an approximately identical positioning on the head of the user and thus any change in orientation sensed by means of the IMU is characteristic of a head rotation and thus also a change in viewing direction. Particularly, the IMU is arranged or adjusted in or on the device body such that a 0° direction of the IMU corresponds at least approximately to a neutral viewing direction (preferentially the sagittal direction) of the user. If the user or at least their head rotates, the room in which the user is located can be “scanned” and thus mapped step by step by means of the CW radar unit.

Knowledge of the distance from objects in a room, particularly from its walls, can be advantageous for signal processing. This is because reverberation effects (also referred to as “reverberations”) of one's own or someone else's speech from the walls can lead to undesired sonic events, particularly to decreased speech perception. Knowledge of the distance can help to decrease such effects, e.g., by adjusting filters correspondingly. Preferentially, the controller is also configured to take into account the distance from walls for the adaptation of parameters during signal processing, particularly by adjusting filter parameters correspondingly. For instance, at least basic settings for a corresponding filter are conceivable. For Hall-effect filters, for instance, settings for small or large rooms, busy rooms, and the like are known. On the basis of the individual distances, an at least rough three-dimensional map of the room in which the user is located can be created. Information on whether or not there are any further people or many pieces of furniture (which would result, for instance, from a wall distance pattern which is uneven in the horizontal but also in the vertical) can be collected and taken into account for this purpose.

According to a further expedient embodiment, the controller is configured to, for establishing the distance, average the digital FFT value over a specified amount of time, particularly over 5 to 40 seconds, preferentially over 15 to 30 seconds. Thereby, the accuracy of establishing the distance can be increased and particularly, short-term influences on the establishment can be decreased.

Particularly in the event that the employed CW radar unit does not have any DC-offset filter in the baseband, according to an advantageous embodiment, the controller is configured to, for establishing the distance, apply a Kalman filter to the radar reception signal. This is because, without such a DC-offset filter, a DC offset is measurable even without the presence of micro-Doppler effects. In this case, multiple DC offsets (particularly successive in time) can thus be sensed. These can be advantageously used for establishing the distance, particularly for enhancing the accuracy, particularly by means of a Kalman filter. Application of Kalman filters, particularly in the field of radar measurements, is known in principle.

According to an expedient embodiment, the controller is configured to establish, from the radar reception signal, particularly its frequency representation, a piece of information on a movement of a body part of the user, particularly their hand, and to utilize this to recognize an input command for a change in a signal processing parameter of the hearing instrument. Particularly, the controller is configured to utilize micro-Doppler effects, particularly in the range of 0 Hz of deviating frequencies, to recognize and evaluate such movements of the body itself (at least within the sensing range of the CW radar unit). Detection of movements of individual body parts by means of micro-Doppler effects is known (cf., e.g.: Geisheimer, J. L., Greneker, E., and Marshall, W. S.: A high-resolution Doppler model of human gait. Proceedings of SPIE on Radar Technology, 2002).

The conjunction “and/or” particularly is to be understood here and hereinafter such that the features linked by means of this conjunction can be designed both jointly and as alternatives to one another. Similarly, the expression “at least one of A or B” should be understood to mean A alone, B alone, or A and B, in either order.

Other features which are considered as characteristic for the invention are set forth in the appended claims.

Although the invention is illustrated and described herein as being embodied in a hearing instrument, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 shows a schematic representation of a hearing instrument with a CW radar unit;

FIG. 2 shows a schematic diagram of a representation of two reflected radar signals in the frequency space; and

FIG. 3 shows a schematic representation of a polar diagram superimposed with a spatial map.

Corresponding parts are provided with the same reference numerals throughout the figures.

### DETAILED DESCRIPTION OF THE INVENTION

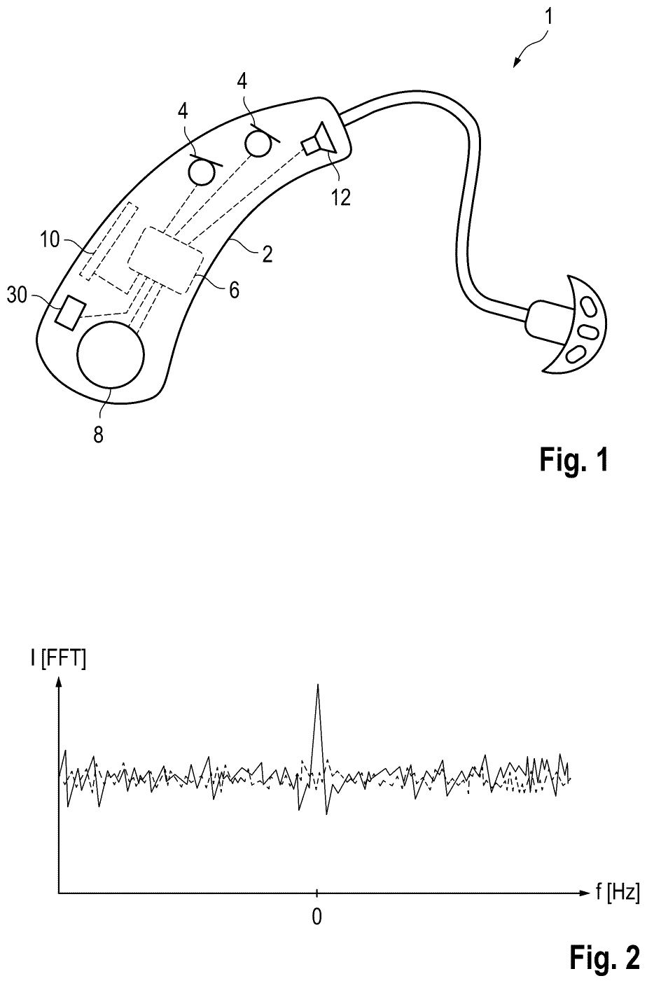

Referring now to the figures of the drawing in detail and first, in particular, to FIG. 1 thereof, there is shown a schematic representation of a hearing instrument, here specifically a hearing assistive device or, for short, a hearing aid 1. The hearing aid 1 comprises a housing 2 which is to be worn on the head of a user, specifically behind their ear. Furthermore, the hearing aid 1 has a number of electronic components arranged in the housing 2. These components include two microphones 4, a signal processor 6 (also: “controller”), an energy source 8 (here specifically a rechargeable battery including control circuits for charging control and energy provision), as well as a CW radar unit, for short: “radar chipset 10.” The housing 2 forms a device body of the hearing aid 1. The microphones 4 are coupled to the signal processor 6 which processes (mixes, filters, amplifies, and the like) the microphone signals. An output signal of the signal processor 6 formed in the process is output to a loudspeaker 12 of the hearing aid 1. In the present exemplary embodiment, this loudspeaker 12 is arranged in the housing 2, but may alternatively also be designed as an external loudspeaker to be worn in the ear canal.

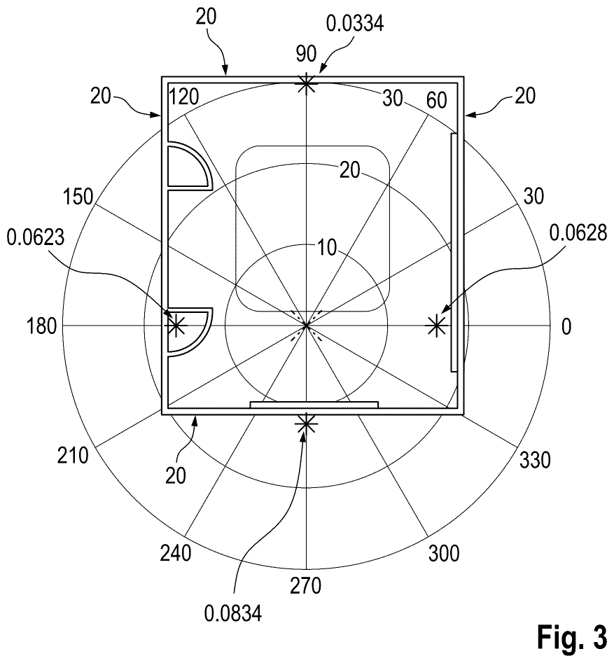

The signal processor 6 is configured to adapt the signal processing (processing) of the microphone signals, for instance, among other things, also as a function of the dimensions of a room in which the user is located, specifically as a function of the distance of the user from one of the walls of the room. This is because the distances of the hearing aid 1 from the walls can be used, for instance, to influence filters or the like, for instance by having filters for what are known as reverberations being able to be adjusted better or activated in the first place. To estimate the distance from an object, specifically a wall 20 of the room (see FIG. 3) in the vicinity of the user, the signal processor 6 is configured to perform a method described in more detail hereinafter.

The signal processor 6 is configured to drive the radar chipset 10 to send out an unmodulated CW radar signal. This is reflected by the walls and other items which are located in the radiation area of a transmitting antenna of the radar chipset 10 (3 dB beam angle, for instance, 65 degrees, each not represented in more detail). The reflected radar signal is received by a receiving antenna of the radar chipset 10 (not represented in more detail). Thereafter, the radar chipset 10 outputs a radar reception signal to the signal processor 6.

The signal processor 6 is configured to detect, in the radar reception signal, a signal portion which is characteristic of a micro-Doppler effect, at least one which is caused by one of the walls 20. Moreover, the signal processor 6 is configured to conclude, from this “characteristic” signal portion, a distance of an object, particularly at least one of the walls 20, from the hearing aid 1.

For this purpose, the signal processor 6 transforms the radar reception signal into its frequency representation by means of a fast Fourier transform (FFT). A frequency of 0 Hz (possibly +/−10-20 Hz) is considered to be a relevant frequency for the micro-Doppler effect since the wall 20 (or any other objects) are assumed to be stationary. The micro-Doppler effects which are discernible in the frequency representation of the radar reception signal (cf. FIG. 2) are caused by slight movements of the user and thus also of the housing 2 (and thus also of the radar chipset 10). A micro-Doppler effect is thus not only caused by the movement of a “target” but also of the transmitter and/or of the receiver.

FIG. 2 represents, by way of example, the FFT representation of the radar reception signal in the event that the housing 2 is motionless and immovable objects are sensed, by means of a dashed curve. In this case, only noise is sensed. Furthermore, FIG. 2 represents the case of the housing 2 worn on the head, wherein only immovable objects are sensed (solid curve). It can be seen that a peak is present in the radar reception signal in the range of 0 Hz.

For 0 Hz, the signal processor 6 first determines the power of the radar reception signal and compares this value (also referred to as a digital FFT DC offset) with a table in which distances are recorded for individual power values. For the highest amplitude, a wall is assumed to be the object. This procedure is underpinned by the consideration that in a room, a wall has a high probability of being the object with the highest reflectivity.

Furthermore, the hearing aid 1 additionally comprises an inertial measurement unit 30, for instance, a 3D acceleration sensor, for sensing the orientation of the hearing aid, particularly of the housing 2, in space. The signal processor 6 is configured to conduct the above establishment of the distance of the hearing aid 1 from an object from the vicinity only when a movement of the hearing aid 1 is sensed by means of the inertial measurement unit 30. Thereby, it can be determined in a simple manner by the signal processor 6 that micro-Doppler effects present in the radar reception signal result from a movement of the user or the hearing aid 1 itself or—particularly if the inertial measurement unit 30 does not indicate any movement of the user—from a movement of, for instance, a larger object in the vicinity of the user.

The signal processor 6 is configured to create a map of the room in which the hearing aid 1 is located. To do this, the signal processor 6 senses the current orientation of the hearing aid 1 in space by means of the inertial measurement unit 30 and can establish the distance from the respective wall 20 for this orientation. FIG. 3 represents this, by way of example, on the basis of a polar diagram in which 0 degrees is at a “3 o'clock position.” Here, the digital FFT DC offset is, by way of example, 0.0628 (here assumed to be unitless) and, for 180 degrees, 0.0623. The user is here thus located approximately on a room central axis. For the 90-degree direction, the digital FFT DC offset is 0.0334, and for 270 degrees, it is 0.0834. The user is thus located with their back closer to the wall 20 there than to the wall 20 at 90 degrees.

For higher accuracy, the signal processor 6 is optionally configured to average the digital FFT value over a period of 30 seconds and over five measurements taken in this period.

It should be understood that the subject of the invention is not limited to the exemplary embodiments described above. Rather, further embodiments of the invention can be derived from the description above by a person skilled in the art. Particularly, the individual features of the invention described on the basis of the various exemplary embodiments and their design variants can also be combined with one another in any other way.

The following is a summary list of reference numerals and the corresponding structure used in the above description of the invention:
1 hearing aid
2 housing
4 microphone
6 signal processor
8 energy source
10 radar chipset
12 loudspeaker
20 wall
30 inertial measurement unit

1. A hearing instrument, comprising:
a device body to be worn on the body of a user;
a continuous wave (CW) radar unit arranged in or on said device body, said CW radar unit being configured to emit an unmodulated CW radar signal, to receive a corresponding reflected radar signal and to output a radar reception signal upon receiving the reflected radar signal; and
a controller configured to detect a signal portion characteristic of a micro-Doppler effect from the radar reception signal output by said CW radar unit and to establish therefrom a distance of said device body from an object in a vicinity of the user.

2. The hearing instrument according to claim 1, wherein said controller is configured to break down the radar reception signal into frequency constituents thereof.

3. The hearing instrument according to claim 2, wherein said controller is configured to break down a characteristic signal portion of the radar reception signal into the frequency constituents thereof by way of a fast Fourier transform.

4. The hearing instrument according to claim 1, wherein said controller is configured to establish the distance by determining a digital fast Fourier transform value of a characteristic signal portion of the radar reception signal.

5. The hearing instrument according to claim 4, wherein said controller is configured to determine a DC offset of the characteristic signal portion of the radar reception signal.

6. The hearing instrument according to claim 4, wherein said controller, for establishing the distance, is configured to utilize the FFT value of the characteristic signal portion at a frequency of 0 Hz.

7. The hearing instrument according to claim 4, wherein said controller, for establishing the distance, is configured to utilize the FFT value of the characteristic signal portion within a frequency range of 0+/−20 Hz.

8. The hearing instrument according to claim 4, wherein said controller is configured to compare the FFT value with a recorded amount of FFT comparison values, each of which is associated with a respective distance value.

9. The hearing instrument according to claim 1, further comprising:
an inertial measurement unit arranged in or on said device body and configured for determining any change in orientation of said device body in space; and
wherein said controller is configured to establish the distance of said device body from the object by way of said CW radar unit when a change in orientation of said device body is indicated by said inertial measurement unit.

10. The hearing instrument according to claim 4, wherein said controller, for establishing the distance, is configured to average the digital FFT value over a specified amount of time.

11. The hearing instrument according to claim 10, wherein the specified amount of time is 5 to 40 seconds.

12. The hearing instrument according to claim 10, wherein the specified amount of time is 15 to 30 seconds.

13. The hearing instrument according to claim 9, wherein said controller is configured to create, on a basis of the distance and an item of solid-angle information regarding a viewing direction of the user, as established by way of said inertial measurement unit, an ambient map containing distances between the hearing instrument and items in the vicinity of the user.

14. The hearing instrument according to claim 13, wherein said controller is configured to create the ambient map with walls or other objects in a room in which the user is located.

15. The hearing instrument according to claim 1, wherein said controller is configured to, for establishing the distance, apply a Kalman filter to the radar reception signal.

16. The hearing instrument according to claim 1, wherein said controller is configured to establish, from the radar reception signal, an item of information on a movement of a body part of the user and to utilize the movement to recognize an input command for a change in a signal processing parameter of the hearing instrument.

17. The hearing instrument according to claim 1, wherein said controller is configured to use a frequency representation of the radar reception signal to establish information on a movement of a hand of the user and to use the information to recognize an input command for a change in a signal processing parameter of the hearing instrument.
